(19) United States
(12) Patent Application Publication
(10) Pub. No.: US 2025/0246007 A1
(43) Pub. Date: Jul. 31, 2025

(54) FEATURE MEASUREMENT FOR GEM IDENTIFICATION

(71) Applicant: Gemological Institute of America, Inc., Carlsbad, CA (US)

(72) Inventor: Thomas Scott Hemphill, Lexington, MA (US)

(21) Appl. No.: 19/043,276

(22) Filed: Jan. 31, 2025

Related U.S. Application Data
(60) Provisional application No. 63/627,699, filed on Jan. 31, 2024.

(51) Int. Cl. G06V 20/64; G06F 16/2457; G06T 7/13; G06T 17/00; G06V 10/12

(52) U.S. Cl. CPC G06V 20/653; G06F 16/24578; G06T 7/13; G06T 17/00; G06V 10/12; G06V 2201/12

(57) ABSTRACT

Systems and methods for identifying gemstones include systems and methods for obtaining a set of measurements for a gemstone, deriving measurements of edges and/or facets of the gemstone and creating feature sets based on the derived measurements for comparison and matching to recorded features of gemstone records in a database. Systems and methods for creating a database of gemstone records are also described.

### RELATED APPLICATION

This application claims the benefit under 35 U.S.C. § 119 (e) of U.S. Provisional Patent Application No. 63/627,699, filed Jan. 31, 2024, which is incorporated herein by reference.

### TECHNICAL FIELD

The field of the present disclosure includes systems and methods for utilizing measured features for analyzing, comparing, and/or identifying a diamond or other gemstone, or other polyhedral items.

### BACKGROUND

Gemstones are commonly classified and graded based on characteristics such as carat weight, color, cut, clarity, etc. Such characteristics can be accurately determined by a trained gemologist and recorded for grading purposes and for future reference. However, the collection of such characteristics is insufficient to uniquely identify a specific gemstone as apart from all other gemstones, as many gemstones share the same set of such characteristics.

Efforts to create a record that uniquely identifies a gemstone apart from all others have historically included detailed information on both the classifiable characteristics of the gemstone (weight, color, cut, clarity, etc.) as well as a list inclusions and other flaws observed by an expert gemologist that provide a sort of fingerprint of the gemstone. However, such detailed analysis is time consuming, such records are difficult to search, and not all gemstones have obvious flaws. Some gemstones, particularly diamonds, are inscribed (e.g., by a laser) along a girdle of the gemstone with a unique serial number or certification number that is recorded in a database, typically as an index to a record of the gemstone's characteristics. However, not all gemstones are inscribed in this manner and there are various drawbacks to inscribing gemstones. For example, inscriptions can be removed or forged.

A number of other technological methods have been proposed in the past for identifying gemstones based on reflection and light scattering measurements, ion implantation, and others. However, none have achieved widespread use, largely due to the high cost and cumbersome equipment or procedures required to utilize them, or the lack of reproducibility when using different equipment or under different environmental conditions.

For example, Patent Application Publication No. US 2018/0082116 A1 describes capturing a representative group of images of a gemstone from different viewing angles, generating a set of rotation-invariant values informative of rotational cross-correlation relationship characterizing the images, and using the generated set of rotation-invariant values to generate a unique identification associated with the gemstone. Methods described include creating composite images from which the cross-correlation relationship can be derived, and are likely to be computationally and memory intensive, particularly as the number of gemstones contained within the database grows.

There remains a need for an improved systematic and easily reproducible gemstone identification system and method that facilitates reliably matching of a gemstone to a unique historical record of the same gemstone in a relatively compact database.

The present applicant believes that a new system and method that could reliably match a gemstone to a prior record of the gemstone in a database of measured shape features of gemstones would greatly enhance the ability to identify and grade a gemstone.

### SUMMARY

Systems and methods are described herein to identify gemstones, and for creating and searching a database of gemstones and their features for matches and likely matches to thereby identify a gemstone.

Systems and methods for identifying a gemstone described herein may involve the use of measured shape features to identify gemstones, and methods of creating and searching databases of gemstones and their measured features to identify matches or likely matches.

Systems and methods of identifying gemstones described herein may include obtaining a set of measurements for a gemstone, such as a set of related shape measurements. The set of shape measurements can include measurements regarding vertices, edges, and/or facets of the gemstone, such as one or more of positions (coordinates) of vertices, distances between vertices, positions of facets, angles between facets, relationships between vertices, relationships between facets, and relationships between vertices and facets. The step of obtaining the set of measurements of the gemstone may include obtaining measurements of relative or absolute positional or angular relationships between vertices, edges, and/or facets of the gemstone. The set of measurements can be obtained by a digital camera capturing images of the gemstone at various angles or as the gemstone is rotated via a rotating stage relative to the digital camera. The set of measurements may be derived from one or more pixelated images of the gemstone and the method or system may include detecting multiple edges and/or vertices in the pixelated images of the gemstone. A three-dimensional model of the gemstone may be generated using the detected edges and/or vertices. In some embodiments the method or system may involve deriving, from the three-dimensional model, distances between vertices and angles between facets.

The system or method can also include generating at least one feature from a portion of the set of measurements within a region of the gemstone. For example, a feature may comprise one or more shape measurement elements such as distance measurements between two or more adjacent vertices and/or angles between adjacent facets that adjoin along edges between the adjacent vertices. A feature may comprise one or more different shape measurement elements, and may typically include two, three, four, five or six different shape measurement elements.

The system or method can include grouping subsets of the shape measurements into multiple feature sets, each of the feature sets defining a feature of the gemstone. At least some of the feature sets may include at least the length of a first one of the edges and an angle between adjacent facets that meet along the first one of the edges. Each feature may comprise one or more values specifying measurements of the feature set corresponding to the feature. The values may be bin numbers representing a range of measurements. Each of the features may be part of a taxonomy of features classifying each feature by feature type. In some embodiments of the system and method, the subset of measurements comprising each of the feature sets may be devoid of measurements of edges or facets of the gemstone that are not adjacent to at least one other edge or facet for which at least one measurement thereof is included in the subset.

The system or method may also include identifying a matching gemstone record in a database by comparing the features of the gemstone to one or more gemstone records stored in the database. Each of the gemstone records may including multiple recorded features representing record feature sets consisting of one or more measurements. Comparing the features of the gemstone to the one or more gemstone records may include comparing each the features of the gemstone to at least one of the recorded features in the database to identify multiple matching features. Each of the recorded features in the database may include a recorded feature set stored in the database, wherein each of the recorded feature sets is associated with at least one of the gemstone records. Each of at least some of the recorded feature sets may be associated with multiple gemstone records in the database. Identifying one or more matching gemstone records may further include defining a metric used to determine which of the recorded features in the database are within a threshold similarity to each of the features of the gemstone. The metric may be a Manhattan metric or Euclidian metric that is pre-scaled such that a distance, in a coordinate space, between one of the feature sets and a corresponding recorded feature set is below a threshold value.

Each gemstone record in the database has a corresponding control number or other unique identifier stored in the database, which is stored in connection with the recorded features and/or recorded feature sets of the gemstone record.

The system or method may further include scoring at least some of the gemstone records based on their similarity to the gemstone to generate a similarity score. The similarity score may be based on the quantity of matching features relative to a total quantity of recorded features of the corresponding gemstone record in the database. A relative score may also be generated for at least some of the gemstone records based on the similarity scores for multiple gemstone records in the database.

The system and method may populate a list with control numbers of at least some of the gemstone records, or with the matching gemstone records or a subset thereof. The list may be based on the similarity scores, such as being ranked based on the similarity scores. For each control number populated in the list, the method or system may assign a label specifying whether the corresponding gemstone record is predicted to be the best matching gemstone record based on the similarity scores computed. And the list may be displayed with the labels.

The system or method can also include omitting one or more of the measurements from the feature, or omitting features that contain certain measurements. Omitted measurements or features can include features that encompass a girdle of the gemstone, a distance or angle measurement of a girdle facet, or a measurement where angles between two facets are within a threshold planar similarity. For example, the system or method may exclude feature sets having edge length measurements below a predetermined minimum length threshold and or angular measurements within a predetermined coplanar threshold. In some embodiments of the system and method, none of the features generated includes a distance measurement or an angular measurement of any portion of a girdle of the gemstone.

The system and method can also include storing one or more features that are part of a wireframe model of a gemstone under evaluation (also referred to herein as “test wireframe”) in a searchable database configured to store wireframe feature data on numerous gemstones.

In some embodiments of the system and method, the database includes gemstone records comprised of recorded features representing or including recorded feature sets consisting of one or more measurements. Each of the recorded feature sets may include a predetermined number of measurements, which may correspond to a feature taxonomy. And the step of grouping subsets of the measurements of the gemstone into feature sets may include grouping a number of such measurements corresponding to the predetermined number of measurements of at least one of the recorded feature sets. In some embodiments, the predetermined number of measurements of each one of the recorded feature sets does not exceed six measurements.

In another implementation, a non-transitory computer readable media with computer-executable instructions thereon may be configured to instruct a processor to perform a series of steps including obtaining a set of measurements of a gemstone, grouping subsets of the measurements into multiple feature sets defining features of the gemstone, and identifying one or more matching gemstone records in a database by comparing the feature of the gemstone to gemstone records in the database. Each of the gemstone records may include multiple recorded features representing record feature sets consisting of one or more measurements, and comparing the features of the gemstone to the one or more gemstone records may include comparing each the features of the gemstone to at least one of the recorded features in the database to identify multiple matching features.

Each of the recorded features in the database may include a recorded feature set stored in the database which is associated with at least one of the gemstone records. Each of at least some of the recorded feature sets may be associated with multiple gemstone records in the database.

The instructions to identify one or more matching gemstone records may include identifying, for each of the features of the gemstone, all recorded feature sets in the database that match the feature set of the feature within a threshold similarity. The instructions may further be operable to cause a processor to compute a similarity score for each of a plurality of the gemstone records based on a quantity of the features of the gemstone that match recorded features of said gemstone records. The instructions may also be operable to further instruct the processor to populate a list with the control numbers of at least some of the plurality of gemstone records, based on the similarity scores.

The method can also include identifying, for a specified or identified feature of a gemstone under evaluation, all matching features in the searchable database. The matching features can be sorted by database wireframe. The method can also include scoring each of the matching features based on a similarity to the specified or identified feature in the test wireframe. The method can also include populating a table with a number of database wireframes based on the scores for each of the matching features of each database wireframe.

In some instances, each feature comprises one or more values specifying measurements associated with the feature.

In some instances, the one or more features are part of a taxonomy of features classifying each feature by feature type. The feature of a particular gemstone may defined by its classification in the taxonomy and the values specifying the corresponding measurements of the shape elements of the feature

In some instances, identifying the matching features in the searchable database further includes defining a metric used to determine whether each feature in the searchable database is within a threshold similarity to the specified (measured) feature. The metric can be any transformation of the measurement data.

In some instances, the metric comprises any of a Manhattan metric and a Euclidian metric that is pre-scaled such that a distance between measurement sets in a coordinate space is to be below a threshold value to be considered a match.

In some instances, the method can also include assigning, for each wireframe populated in the table, a label specifying whether the wireframe is predicted as a match based on the scores for each matching feature of each database wireframe and causing display of the table with labels associated with each of the number of wireframes.

In some instances, the score is a product of all matching features for each database wireframe relative to all total features of the database wireframe and the test wireframe.

In some instances, the method can also include generating, for each database wireframe, a relative score based on the score for matching features of each database wireframe against another score of features for another database wireframe.

In some instances, the set of measurements for the gemstone are obtained by one or more images of the gemstone. The one or more images can be captured by: causing rotation of the gemstone on a stage and capturing, by a digital camera, the one or more images of the gemstone as the gemstone rotates on the stage, relative to the digital camera.

In some instances, deriving the set of measurements from the one or more pixelated images of the gemstone further comprises determining an edge of the gemstone, generating a three-dimensional model of the gemstone using the determined edges, and deriving distances and angles of facets, vertices, and edges from the generated three-dimensional model. The set of measurements can be derived from the derived distances and angles of facets, vertices, and edges.

In another example embodiment, a non-transitory computer readable media with computer-executable instructions thereon configured to instruct a processor to perform a series of steps is provided. The series of steps can include obtaining a set of measurements for a gemstone, the set of measurements measuring at least distances between vertices, positions of facets, and angles between facets. The series of steps can also include generating at least one feature from a portion of the set of measurements within a region of the gemstone as depicted in the one or more pixelated images.

The series of steps can also include identifying, for a specified feature, all matching features in a searchable database. The matching features can be sorted by database wireframe. The series of steps can also include scoring each of the matching features based on a similarity to the specified feature. The series of steps can also include populating a table with a number of database wireframes based on the scores for each of the matching features of each database wireframe.

In some instances, the instructions further instruct the processor to perform steps comprising removing one or more of the measurements from the feature, wherein the one or more measurements include a distance or angle measurement of a girdle facet, or a measurement where angles between two facets are within a threshold planar similarity.

In some instances, each feature comprises one or more values specifying measurements of each measurement of the portion of the set of measurements associated with the feature.

In some instances, the one or more features are part of a taxonomy of features classifying each feature by feature type.

In some instances, identifying the matching features in the searchable database further includes defining a metric used to determine whether each feature in the searchable database is within a threshold similarity to the specified feature, wherein the metric comprises any of a Manhattan metric and a Euclidian metric that is pre-scaled such that a distance between measurement sets in a coordinate space is to be below a threshold value to be considered a match.

In some instances, the instructions further instruct the processor to perform steps comprising assigning, for each wireframe populated in the table, a label specifying whether the wireframe is predicted as a match based on the scores for each matching feature of each database wireframe and causing display of the table with labels associated with each of the number of wireframes.

In some instances, the score is a product of all matching features for each database wireframe relative to all total features of the database wireframe and the test wireframe.

In some instances, the instructions further instruct the processor to perform steps comprising generating, for each database wireframe, a relative score based on the score for matching features of each database wireframe against another score of features for another database wireframe.

In another example embodiment, a system for analyzing gemstones is provided. The system can include a digital camera configured to capture multiple images of a gemstone and a computer with a processor and memory, in communication with the digital camera.

The computer is configured to obtain the multiple images of the gemstone from the digital camera. The computer is also configured to derive a set of measurements from the one or more images of the gemstone, the set of measurements measuring at least distances between vertices, positions of facets, and angles between facets. The computer is also configured to generate at least one feature from a portion of the set of measurements within a region of the gemstone.

The computer is also configured to remove one or more of the measurements from the feature, wherein the one or more measurements include a distance or angle measurement of a girdle facet, or a measurement where angles between two facets are within a threshold planar similarity. The computer is also configured to store the at least one feature that are part of a test wireframe in a searchable database configured to store features associated with wireframes for one or more other gemstones. The computer is also configured to identify, for a specified feature, all matching features in the searchable database, wherein the matching features are sorted by database wireframe. The computer is also configured to score each of the matching features based on a similarity to the specified feature in the test wireframe. The computer is also configured to populate a table with a number of database wireframes based on the scores for each of the matching features of each database wireframe.

In some instances, the computer is further configured to assign, for each wireframe populated in the table, a label specifying whether the wireframe is predicted as a match based on the scores for each matching feature of each database wireframe and cause display of the table with labels associated with each of the number of wireframes.

### BRIEF DESCRIPTION OF THE DRAWINGS

For a better understanding of the embodiments described in this application, reference should be made to the Detailed Description below, in conjunction with the following drawings in which like reference numerals refer to corresponding parts throughout the figures.

FIG. 1 is an illustration of a gemstone comparison in accordance with certain aspects described herein;

FIG. 2 is an illustration of gemstone analysis in accordance with certain aspects described herein;

FIG. 3 is an illustration of gemstone database features in accordance with certain aspects described herein;

FIG. 4 is an illustration of gemstone feature analysis in accordance with certain aspects described herein;

FIG. 5 is another illustration of gemstone feature analysis in accordance with certain aspects described herein;

FIG. 6 is another illustration of segregated gemstone feature analysis in accordance with certain aspects described herein;

FIG. 7 is another illustration of segregated gemstone features in accordance with certain aspects described herein;

FIG. 8 is an illustration of gemstone database lookup architecture in accordance with certain aspects described herein;

FIG. 9 is an illustration of gemstone database results in accordance with certain aspects described herein;

FIG. 10 is an illustration of gemstone database analysis in accordance with certain aspects described herein;

FIG. 11 is another illustration of gemstone database results in accordance with certain aspects described herein;

FIG. 12 is a flow chart showing example method steps in accordance with certain aspects described herein; and

FIG. 13 is an illustration of an example computer system in accordance with certain aspects described herein.

### DETAILED DESCRIPTION OF EXEMPLARY EMBODIMENTS

Reference will now be made in detail to embodiments, examples of which are illustrated in the accompanying drawings. In the following detailed description, numerous specific details are set forth in order to provide a sufficient understanding of the subject matter presented herein. But it will be apparent to one of ordinary skill in the art that the subject matter may be practiced without these specific details. Moreover, the particular embodiments described herein are provided by way of example and should not be used to limit the scope of the particular embodiments. In other instances, well-known data structures, timing protocols, software operations, procedures, and components have not been described in detail so as not to unnecessarily obscure aspects of the embodiments herein.

### Overview

Systems and methods here may be used for measuring various aspects of any kind of polyhedron including, but not limited to gemstones, analyzing of the measurements for the polyhedron, quantifying features on those polyhedrons, and entering those quantified values into databases for later comparison. Such a database may be searchable using analyzed and quantified features of a new sample polyhedron to allow for matching with a previously analyzed polyhedron in the database.

In a first example, the polyhedron is a gemstone. Various aspects of the gemstone can be measured, and these measurements can be used to generate a wireframe uniquely representing a set of features of the gemstone. The wireframe can quantify aspects of the gemstone by identifying features (e.g., positions of facets, edges, angles between facets and edges) of the gemstone.

The wireframe can be further stored in a searchable database for further analysis. For example, wireframes for multiple gemstones can be stored in a database and used for further analysis of gemstones, such as to identify a frequency of a specific feature type among multiple wireframes, or a correlation between features of different gemstones, for example.

Example steps that may be employed to achieve these goals can include collecting measurement data. The measurement information can come from any numerous sources or programs. For example, measurement information can be obtained from a system comprising an imaging device capturing images of the gemstone and/or a stage rotating the gemstone. Further, the system can include a computer or computer program capable of determining measurement information from images captured by the imaging device. The measurement information can also be obtained from another information source, such as from another computer transmitting measurement of a gemstone for analysis as described herein.

The steps can also include extracting features from the measurement data describing the portions of the polyhedral geometry of the surface of the gemstone. The features can include adjacent edges, adjacent facets, etc. of the gemstone and measurements depicting locations of these features, for example.

In some instances, the steps can also include generating a set of features that comprise a wireframe or wireframe file uniquely identifying the measured polyhedral features of the gemstone. The wireframe can be represented as a data structure (e.g., a half-edge data structure) comprising a number of features derived from various shape measurements of the gemstone.

The steps can also include storing the feature data of the wireframe in a database correlated to an identifier for the gemstone. The database can store feature data (e.g., wireframes) for multiple gemstones and can be used for processing features of a plurality of gemstones as described herein.

In some instances, when a new polyhedron is measured, each of its features can be searched for in the database. For example, a new gemstone can be measured, and the measurement data can be compared against other wireframes in the database to determine if a match is present. The database gemstones with the greatest number of matching features can be considered to be candidates for a match to the gemstone under evaluation. This set of likely matches may be further analyzed for confidence level.

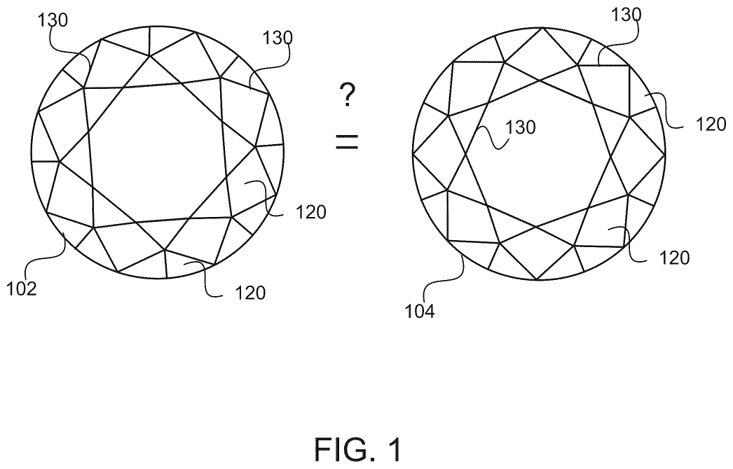

As a non-limiting example, a gemstone may be analyzed and stored in this way for comparison and later identification purposes. FIG. 1 shows an example of how such a system and methods may be used by showing a table down view of two gemstones 102, 104, which may be the same gemstone analyzed at two different times or two different gemstones. Different gemstones can look similar, and indeed, may possess many of the same characteristics such as carat weight, cut, color and/or clarity grade, but still may be two different gemstones. A much more accurate set of measurements may be used to make a positive match to a stored record of a gemstone when the same gemstone is analyzed at a later time. One such example may include analysis of the facets 120 of gemstone, or flat faces polished on the gemstones. Such analysis may also include analysis of the vertices 130 which are the points where the three or more facets meet. In some examples, analysis of both the facets and vertices may be utilized as explained herein.

For example, systems and methods here may be used to store wireframe data for a gemstone (also referred to herein as a “stone”) into a database by converting a wireframe data file to an internal half-edge data structure, calculating all the features in the wireframe, and storing the feature data in a database along with a unique identification code or other identifier (ID) of the corresponding gemstone.

Once wireframes and feature data are stored, systems and methods described herein may be used to identify stored wireframes which match the wireframe of a gemstone under evaluation (test stone) by converting its wireframe file to an internal half-edge data structure. This may include calculating all the features in the wireframe of the gemstone under evaluation and, for each feature thereof, looking up all the wireframes in the database which include that feature, and storing the results in a table in memory. In some examples, the table may be used that includes, for each gemstone ID identified in the database, a tally of the number of matching features, determining which gemstones in the database are a match for the gemstone under evaluation based on how many features are found in each gemstone ID, and generating an output of the gemstone IDs, if any, that are found to have matching wireframes.

### Wireframe Data Collection

As mentioned, a wireframe model of any kind of polyhedron may be utilized in the systems and methods described herein. The source of such wireframe could come from many sources, such as computer programs or image collection sources. But in one such example embodiment, a cut gemstone may be measured to determine the number, dimensions, and relative positions of facets of the cut gemstone, angles between adjacent facets, the vertices where three or more facets meet on a cut gemstone, and the distances between adjacent vertices. In some embodiments, only some of such information for a cut gemstone may be collected, for example on only selected regions of the gemstone, and may yield only a partial wireframe.

Various data formats of each wireframe may be utilized in the systems and methods here. Such data formats can be inputs for the feature recognition and data storage for future matching purposes and could be any of various formats.

One such example format is a Point-Polygon representation using a subset of a DirectX file format. Another example is a Plane Equation representation using a GemCAD file format. Other data formats may be utilized as well, but in any case, the data is converted by the systems and methods here to an internal memory format.

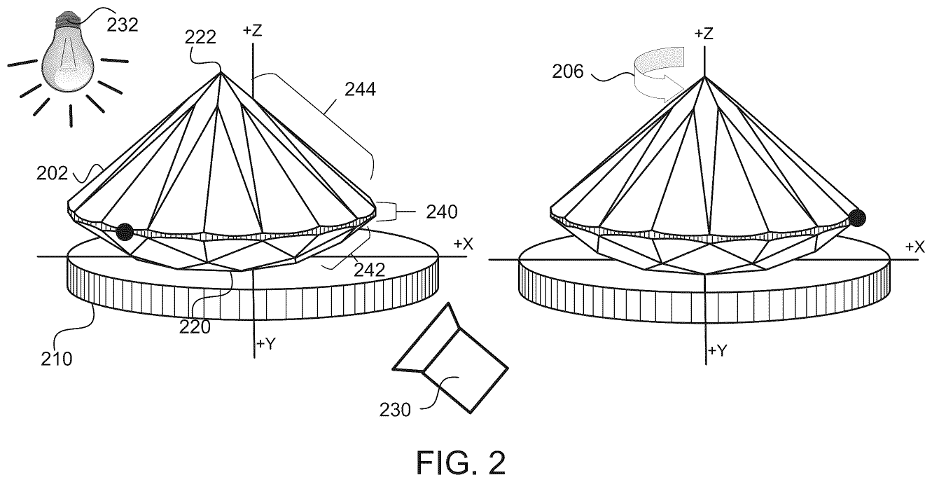

Many different methods may be used to create a wire diagram of the facets on a cut gemstone, and the methods of facet determination and matching are agnostic as to how the wireframe is determined for any polyhedron. One such non-limiting example of such measurement may include using a visible light camera and a background white light to capture images of a cut gemstone to measure and quantify the measurements for analysis. FIG. 2 shows a gemstone 202 resting on a stage 210. In some examples, the gemstone 202 is placed on the stage 210 with table side 220 down and culet 222 up. A coordinate system of X, Y, and Z, 250 may then define the dimensions and angles of the gemstone 202.

On one side, a camera 230 may be placed, and on the other side from the diamond 202, a light 232 may be placed, in such a way, the camera 230 may view the diamond 202 as a silhouette because of the back lighting arrangement, but such arrangement may allow for the digital images captured by the camera to measure the angles and dimensions of the gemstone 202 using the pixels in the images. By then turning 206 the gemstone 202 by rotating the stage 210, many images of the gemstone 202 silhouette may be captured by the camera 230. Once the digital images are captured, the computer may then detect the silhouette or edge of the gemstone in the pixelated image. In some examples this may include using image processing step called edge detection. Equations of the detected edges may then be incorporated into a generated three-dimensional model of the gemstone 202. In such examples, the distances and angles may be derived from the three-dimensional model, not from a profile view, in examples where distances and angles required for analysis do not appear in the profile view. In some examples, distances and angles of edges may be determined by counting the pixels in the images and extrapolating the distances and angles using algorithms in combination with the counted pixels. Using a known dimension of each pixel, the computer may assign dimensions to the gemstone to generate coordinates of each facet and each of the vertices of the intersections of the facets as angles.

A girdle 240 of the gemstone 202 constitutes a narrow band encircling the gemstone 202 between a crown 242 and a pavilion 244 of the gemstone 202. The girdle 240 may be a region which is rounded or faceted, but with such small facets that measuring them separately may not be of any value in the identification systems and methods described herein. For example, the measuring system may approximate or assign facets to the girdle section 240 of the gemstone 202 when measuring the silhouette with the camera 230, but such measurements may end up being mere approximations or mathematical estimates because of the small size of the girdle and/or its shape being a round or curved facet instead of a flat one. In such examples, and for these reasons, the systems and methods here may or may not include the measurements of the girdle for database storage and/or identification comparisons.

Feature and Feature Types are Extracted from the Wireframe Examples

In some examples, subsets of the measurements are grouped into multiple feature sets, each representing or defining a feature. The features are used for comparisons and matching for identification as described herein. A feature may refer a set of related measurements collected from or derived from a region of a wireframe model. Such features may be one or more measurements from a location on a surface of a gemstone or polyhedron. Each feature can include a number of measurements, such as distance measurements (a distance between two vertices) and angle measurements (an angle between two facets). Thus, in some examples, measurements of features may include a length of an edge, an angle between two facets (taken at the edge between the two facets), a distance between a vertex and a reference plane, and/or an angle between a facet and a reference plane.

In some instances, a feature can include a set of measurements collected from a region of the wireframe. The measurements can include distances between vertices and/or angles between facets. In some instances, the measurements can also include distances between a vertex and the stage of the measuring device, and angles between facets and the plane of the stage.

There are different ways of selecting which distance and angle measurements are used to define a feature, and the present embodiment can include features that contain anywhere from 1 to 12 different measurements. In some instances, features can include either 2 or 6 measurements per feature.

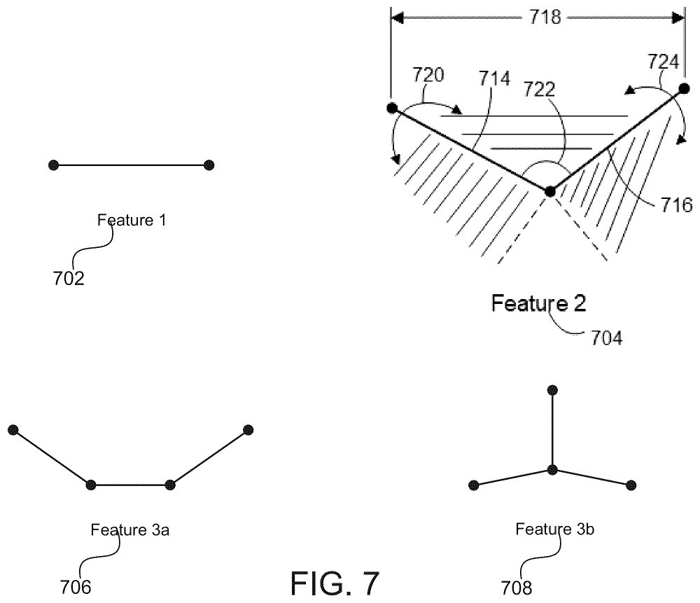

Further, a taxonomy of features can be considered, which can be shown in FIG. 7, for example. An example of features can include 0az, 0bz, 1, 1z, 2, 2z, 3a, 3az, 3b, 3bz, which are described in greater detail below.

When determining which features to measure and utilize, it may be helpful to review common gemstone shapes and cuts. For example, diamond measuring devices may have a natural reference plane: the plane of the stage that the diamond is placed on. Most diamond cuts have a table facet that is placed on the stage to perform the measurement (220 from FIG. 2). However, if using example measurements of a distance between a feature vertex and a reference plane and/or an angle between a feature facet and a reference plane, values may change if the table is re-faceted. This may reduce later comparison effectiveness. Thus, one example reason to use example measurements a length of a feature edge and/or an angle between two facets (taken at the edge between the two facets), is that measurements will remain unchanged if the stone (gemstone) is re-faceted elsewhere, enabling stone wireframes to still be matched in a database comparison. Another example measurement is an interior facet angle. Interior facet angles may be determined by the distances between vertices and thus may provide no new information.

A feature type may be defined by a specific set of measurements. All the measurements collected in a small region can be stored together as a single feature in a database.

Example features types may include those below, where the number in a feature type indicates how many edges are used in the feature type definition. The letter “a” or “b” distinguishes between two feature types with the same number of edges. The letter “z” indicates that the feature type makes use of measurements with respect to a reference plane.

Feature type 0az—Choose a vertex. The feature consists of one measurement: the distance between that vertex and a reference plane.

Feature type 0bz—Choose a facet. The feature consists of one measurement: the angle between that facet and a reference plane.

Feature type 1—Choose an edge. The feature consists of two measurements, the distance between the vertices at each end of the edge, and the angle between the facets on each side of the edge.

Feature type 1z—Choose an edge. The feature consists of six measurements: the distance between the vertices (v1,v2) at each end of the edge, and the distance between vertex v1 and the reference plane, and the distance between vertex v2 and the reference plane, and the angle between the facets (f1,f2) on each side of the edge, and the angle between facet f1 and the reference plane, and the angle between facet f2 and the reference plane.

Feature type 2—Choose a facet (f1) and choose two of its edges which are connected to each other (e1,e2). I also impose the constraint that e2 immediately follows e1 in a counter-clockwise direction as viewed from the outside of the wireframe. When proceeding counter-clockwise, the first vertex of e1 is (v1), the vertex which is shared by e1 and e2 is (v2) and the final vertex of edge e2 is (v3). The facet f1 is on the left side of edge e1 and is also on the left side of edge e2. The facet (f2) is on the right side of e1, and the facet (f3) is on the right side of e2. The feature consists of six measurements: the distance between vertices v1 and v2, and the distance between vertices v2 and v3, and the distance between vertices v3 and v1, and the angle between facet f1 and f2, and the angle between facet f3 and f1, and the angle between facet f2 and f3.

Feature type 3a—Choose a facet (f1) and choose three of its edges which are sequentially connected in a clockwise direction around the facet. The edges are (e1,e2,e3). They connect four vertices (v1,v2,v3,v4) and three additional facets (f2,f3,f4). There are a total of twelve measurements, the first six distances between each of the vertices, taken in pairs, and the next six, angles between each of the facets, taken in pairs.

Feature type 3b—Chose a vertex (v1) and choose three of the edges that connect sequentially at that vertex. The edges are (e1,e2,e3). The other vertices for these edges are (v2,v3,v4). There are, in general, four facets (f1,f2,f3,f4) which come together at the three edges. There are a total of twelve measurements, the first six of distances between each of the vertices, taken in pairs, and six angles between each of the facets, taken in pairs.

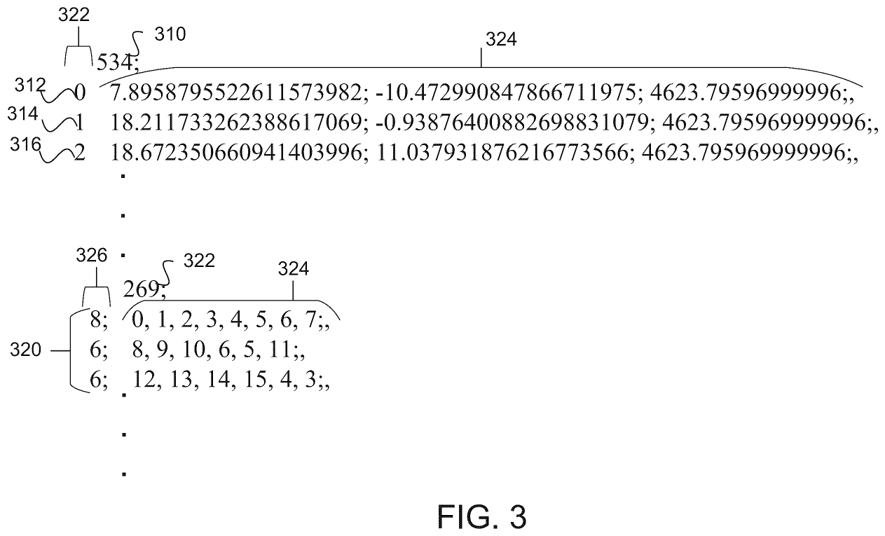

FIG. 3 shows an example of data collected from a sample gemstone defining the coordinates of facets and angled vertices. Such data may be stored in any computerized storage, local, distributed, in a database, table, or any other structure as disclosed herein.

In the example, the first set of numbers relate to the measured vertices. The data indicates for this example, that 534 vertices are found on this particular sample gemstone 310. The coordinates of each of the vertices 312, 314, 316, etc. are listed for each of the measured vertices. In some examples, the first number 322 of the row merely indicates which of the vertices is being referenced, and the coordinates 324 indicate, in a Cartesian frame of reference, the X, Y, Z coordinates in microns, or any other units such as but not limited to millimeters. The example is not intended to be limiting, and some embodiments may utilize different coordinate reference systems (such as polar coordinates), different datums, and/or different coordinate units than microns or millimeters.

Next, the data stored for the example gemstone facets 320 are shown. The example includes 269 facets 322, in this case including the facet coordinates for the girdle, even though such data points may not be eventually used in identification or matching analyses. In this example, each facet of the girdle (240 on FIG. 2) is also shown although such facets are generally mathematical estimations and are not used in identification because they represent such small example facets that are only approximations of facets and therefore not accurate.

The data shows the number of vertices 269 322 and measurements of the lists of vertex numbers. The different rows 320 count the number of vertices 326 and the coordinates for each 324. In some examples, different coordinate units than microns or millimeters may be used, the example not intended to be limiting.

### Wireframe Feature Usage Examples

After the raw data of a polyhedron, for example, gemstone is captured, the computer systems may calculate coordinates and dimensions of the facets, edges, and angles of vertices for the polyhedron, for example, gemstone. Using these coordinates and dimensions, they may be grouped into feature sets and used to help identify the gemstone from among other measurements of other stones. Such features may utilize measurements that are not easily changed or manipulated. In some examples, these may be considered invariant features unless a gemstone was recut or re-polished to change its dimensions.

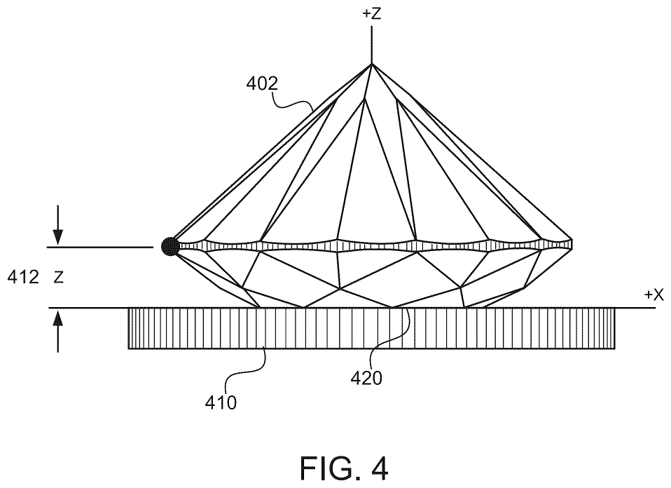

For example, FIG. 4 shows one set of such data, where one feature may refer to a Z coordinate of each of the vertices in a gemstone 402. If a gemstone 402 is set on a stage 410 on the table side 420 down, each of the vertices may have its own Z distance 412 from the stage 410. In such a way, if the table 420 is not re-polished, the distance from the stage 410 and each vertex 412 would remain the same. However, without more, just the Z coordinates of a gemstone vertices may not be enough to distinguish it amongst other gemstones.

Another example feature that may be found on a gemstone may be angles. Such angles 522 may be measured as angles of flat polished facets 520 of the gemstone 502 against a horizontal plane of the table 510. Again, such angles may not be manipulated without re-polishing the gemstone 502 to change such angles 522. Other angles may be used, but measuring the angle 522 against an easily identified and constant such as the horizontal table 510 may be useful in such analysis. Vertices may be three numbers, facets may be lists of vertices, and these two sets may be inputs to the process. Distances and angles may be single numbers, but they may be joined together to form features. For example, Feature 1 may consist of a single distance and a single angle, Feature 2 may consist of three distances and three angles, and Features 3a and 3b may each consist of six distances and six angles, etc. features to be the core of the process. Features may be stored in the database as described herein and results of the database lookup of features in a test stone may result in a list of potential feature matches which may be the output of the process.

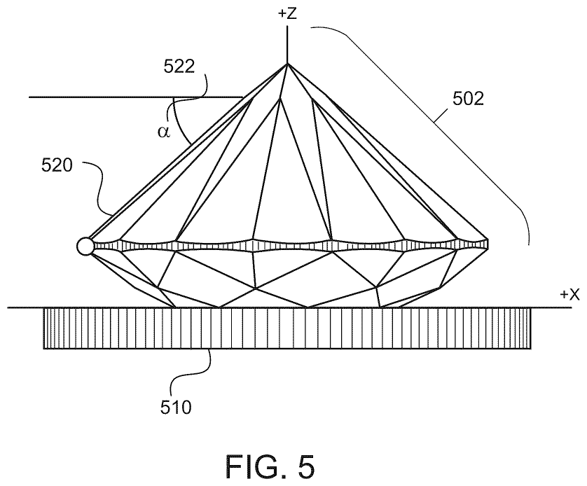

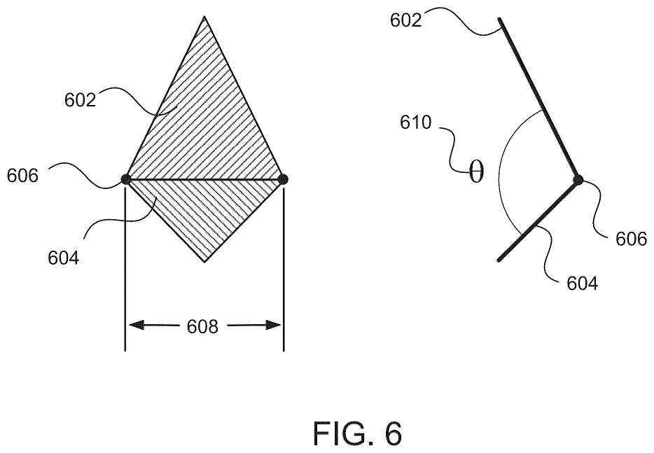

Using the information above, the system may then extrapolate that any given edge on a gemstone may include both a dimensional distance along that edge and an angle between the two facets which make up that edge. FIG. 6 shows these two measurements: where two facets 602, 604 form an edge 606 where the edge 606 may include a measurable distance 608 calculated using the vertex coordinates described above. Also, the two facets 602, 604 may combine to form an angle 610 measured between the two facets 602, 604. Such an angle 610 may be measured differently than the angle in FIG. 5 which is measured against the horizontal stage, in the example of FIG. 6, the angle is the angle formed of two facets 602, F04 forming an edge, not measured against the horizontal.

In such a way, each edge 606 may have two invariant quantities associated with it: distance d of the edge 608, and angle of the angle θ 610 between the two facets 602, 604. Such quantities may be grouped into feature sets to be stored in a database correlated to an identifier for the gemstone which it was measured from, for future comparison and reference as described herein.

By example then, not only could a single edge be measured with two quantities for analysis as shown in FIG. 6, but alternatively or additionally, other more complex feature sets may also be calculated with even more quantities for analysis. FIG. 7 shows more complex example features than FIG. 6, alongside the single edge example 702 of that discussed in FIG. 6. In FIG. 7 the single edge feature 702 is shown with a two edge feature 704 a three sequential edge feature 706, and a three edge intersecting feature 708.

Having explained the two quantities which are measurable and storable for a single edge feature such as 702, in FIG. 6, FIG. 7 shows a two edge feature example 704. In 704, two edges come together 714 and 716. These two edges 714 and 716 may form a feature with six different quantities for measuring and storing. For example, the distance of one edge 714, the distance of the second edge 716, and the overall distance between the farthest points of the two edges 718. Further, angles may be calculated, for example, the angles between the two facets that make up the first edge 714 may form an angle 720. Similarly, the angles between the two facets that make up the second edge 716 may form an angle 724. The angle 722 between the two edges 714, 716 from a top/bottom view may also be calculated. Each of these calculated dimensions may be gathered and stored for comparison analysis, as described herein.

Even more complex examples such as 706 and 708 may produce even more multiple quantities of features for measuring, analyzing, and storing for comparison. Although the more complex examples may provide for more points of analysis, commensurate computing power may be required to then complete the analysis and comparisons at the database to find potential matches. Thus, in some examples, more simple features may be utilized for ease of analysis and the minimum of computing resources. In other examples however, more complex features may result in more accurate comparisons, perhaps for smaller stones, which may be required for proper comparisons.

In some instances, various features can be removed from consideration when generating wireframes as described herein. For example, features that are more likely to contain spurious measurements, such as features containing distance or angle measurements from girdle facets or features with small distances or angles between facets that are close to co-planar can be removed or otherwise omitted. Removing certain features can improve performance in generating and analyzing wireframes as described herein.

When features are being calculated from a wireframe, all possible locations in the wireframe may be chosen consistent with the definition of the feature type. For example, feature type 1 calls for choosing an edge. One choice of edge produces one feature. Choosing different edges produces different features. So, one at a time, choosing all the edges produces a complete list of features in the wireframe. In some examples, feature type 3b may have different usage than feature type 3a in examples where features may be eliminated which include girdle facet edges, since they are artifacts (i.e. not real) of the measurement process. Feature type 3b may allow the measurement of more features than feature type 3a in this situation.

Pseudo-code example implementation of feature type 2:

count = 0
for e1 in wireframe_edges // one at a time, e1 is set to every edge

| | |
|---|---|
| e2 = next(e1) | // edge e2 is next in sequence around facet f1 |
| v1 = vertex(e1) | // vertex v1 is initial vertex of edge e1 |
| v2 = vertex(e2) | // vertex v2 is initial vertex of edge e2 |

v3 = vertex(opposite(e2)) // vertex v3 is final vertex of edge e2

| | |
|---|---|
| f1 = facet(e1) | // facet f1 is on the left of edge e1 |

```
  f2 = facet(opposite(e1)) // facet f2 is on the right of e1
  f3 = facet(opposite(e2)) // facet f3 is on the right of e2
feature[count] = { dist(v1,v2), dist(v2,v3), dist(v3,v1),
    dot(f1,f2), dot(f3,f1), dot(f2,f3) }
count++
```

In the above implementation, “opposite” returns the same edge in the opposite direction in the half-edge data structure. “dist” is the distance between two vertices. “dot” is the dot product of the normal vectors of two facets. This returns the cosine of the angle between the facets. In some examples, the cosine of the angle may be used directly in the database, without solving for the angle itself.

### Database Storage Examples

The systems and methods described herein may be used to not only capture distinguishing features of gemstones, but also store gemstone records including such features and then search them later for finding potential matches for situations where the same stone is analyzed at two different times.

For example, if a distance and angle measurements in a feature were independent and normally distributed, then a feature from a new polyhedron can be compared with a feature in a database by calculating chi-squared. If chi-squared is less than a cutoff value, then the feature from a new polyhedron can be considered a match with the database feature.

If, on the other hand, a distance and angle measurements in a feature were not independent and/or not normally distributed, the same technique can still be employed.

For example, the distance and angle measurements are pre-divided by numbers that take the place of the of the variances in (formula) that are experimentally determined to give the desired matching performance (Type I vs. Type II errors). They are also scaled, so that the chi-square cutoff value becomes one.

The database can be searchable by feature or by measurements that make up a feature. Since there is generally a certain amount of error in the measurements, a metric can be defined that can be used to determine whether a difference between a feature from a test wireframe and a feature in the database is small enough that the features are considered as matching. Such a metric can include a Manhattan metric or a Euclidian metric, which can be based on a Chi-Squared distribution on the measurement errors. The Euclidian metric can be pre-scaled such that the distance between the measurement sets (considered as points in 6D space) are to be less than a value (e.g., 0.5) to be a match.

In some instances, the measurements that constitute a feature of a gemstone can be computed as a hash function (i.e., via a hash function) in order to directly look up a match to a recorded feature in the database, wherein the database includes a hash table encompassing data previously gathered on a large number of gemstones and their features. In some cases, the database can allow for a Euclidean search directly.

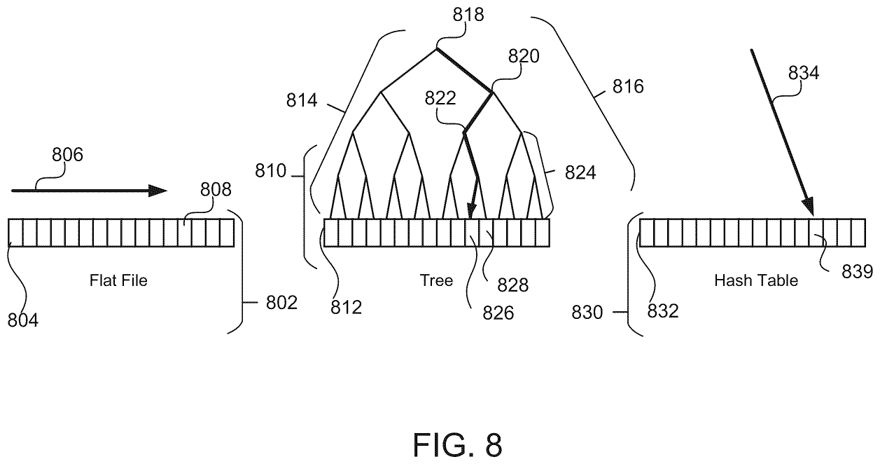

As a background for database searching, FIG. 8 shows examples of database searching methodologies where a query such as a number, is compared to previously recorded numbers in a database file, to see if a match exists. In the example, 802 shows a flat file search, where the database files 804 are searched from one end to the other 806 sequentially until the match is found 808. Such examples demonstrate the most simple search method but such simple searching includes advantages and disadvantages. Such searching may take a long time if the database 804 is large and the match is not found or not found until the end of the file 804 because the search 806 would have to review each file in order. Such searching may be easy to employ however due to the simple nature of merely comparing to each file in the database 804.

The next example 810 shows a tree structure database search methodology. In such an example, the contents of the database file 812 include values that are arranged in some order, for example, numbers in ascending order. The search begins by breaking the numbers in the database file 812 into two halves 814, 816, and comparing the search query to the two halves: the number in the query must be of a value either above or below the break point 818 and thereby reside, if it exists in the database file 812, in one of two halves 814, 816 of the database file 812. By comparing the search to decision tree above or below style queries, the number of search queries may be fewer than in other databases. In the example of FIG. 8, the query falls in the range of the second half 816, thereby reducing the number of database entries to compare to in half. Next, another mid-point break point is found 820 in the remaining portion of the database 816, and compared to the query. Again, the query number must fall within one of the two halves 822, 824 of that portion of the database file 816. These comparisons continue until two data entries in the database 826, 828 are compared to the query and one will either be a match or neither will.

Such a tree structure database query method as shown in 810 has advantages of reducing the number of files searched and thereby the compute power needed to find a match or not, over the flat file 802 where each number in the file must be compared. Another advantage of using a tree structure is that computers using such a search method may include the first few database comparison break points in memory (RAM) cache such that those query comparisons are made quickly, without the need for new disk i/o request for each and every comparison. This again may speed up the process and reduce the compute burden to find a match. Yet another characteristic of using a tree structure database search is that if one object of a search were to find a match or the nearest number to the match, such a query would allow a way to find the two nearest database entries to the query. However, if an actual match were sought, this may not be useful unless a rounding error or measurement error might explain the difference between the query and search result.

The third example of the database searches is a hash table lookup method 830. In a hash table lookup, the query 834 (hash key) is run through an algorithm (the hash function) to determine a hash value, which corresponds to the index of a hash table in a database 836. The database 836 is created by running the values of the database entries 832 through the same hash function to create a hash table. The hashed value of the query 834 is then searched and located in the database entries 836 (i.e., looked up via the index of the hash table) with only one comparison. This single comparison (one-to-one correspondence) has obvious computer resource advantages. However, such advantages may be partially offset by the compute resources needed to run the query through the hash function.

Some databases may comprise a mixture of hashed data (hash tables) and tree data structures linking feature data to gemstones, to facilitate the identification of a particular gemstone from a set of multiple features. In one embodiment, a hash table may be utilized to identify the appropriate tree for lookup, wherein the trees are stored on different servers. In other embodiments multiple hash tables may be visited (e.g. on different servers).

### Database Feature Search Examples

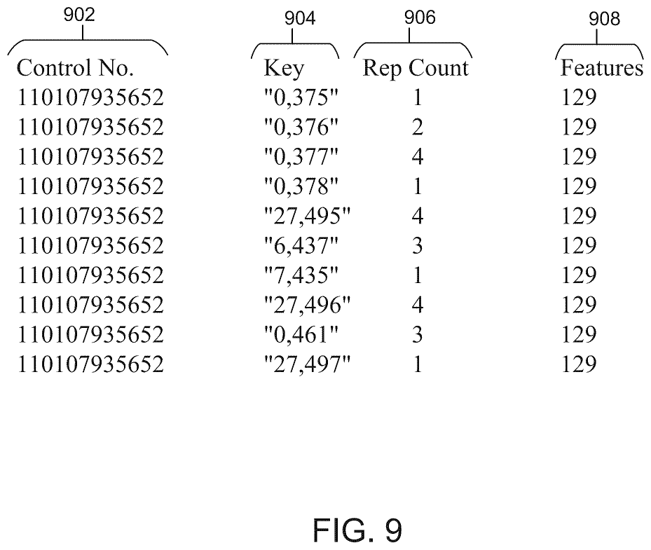

In a comparison example, once a new gemstone is analyzed, and the feature data stored, it may be useful to utilize the example data structure shown in FIG. 9. To search the measured features of a gemstone, the data gathered in the measurements may need a structure to be able to turn into searchable data.

In examples, data from a previously measured stone may be loaded or stored into a database. In such examples, when measured again, the new wireframe feature measurements should match the ones that are already in the database. However, due to measurement error, the features may be slightly different each time the features are measured. In such an example, a single feature from the test stone “t” may be compared with the same feature “x” from the database stone. In the example, we can assume that each measurement in the feature is normally distributed with mean mu_i and standard deviation sigma_i. In general, the measurements can be correlated with one another. An eigensystem analysis of the covariance matrix for a feature will yield a matrix “T” that transforms the feature so that the covariance matrix is the identity matrix, i.e. the standard deviations of the measurements are all one, and they are uncorrelated. Then x′=(x−mu) T and t′=(t−mu) T may both be random variables with a standard normal distribution. If we calculate (x′−t′)/sqrt(2), then it, too, may have a standard normal distribution. And if we sum the squares of these elements, then it has a chi-square distribution.

$$\frac{‖ {x}^{′} - {t}^{′} ‖ \hat{} 2}{2} has a chi - square distribution$$

Rejecting a feature match that should be accepted may be a Type II error. The chance of a Type II error may be set directly by using a percentile value in a table of chi-square values. If a 10% chance of a type II error is desired, then a 90%-ile value for chi-square may be used with the appropriate number of degrees of freedom.

In such examples, the measurement errors may not be normally distributed. And instead of calculating the transform matrix T, the distance measurements may be divided by an assumed standard deviation sigma_d, and all the angle measurements by an assumed standard deviation sigma_a. These standard deviations may be assumed constant for all features. Also, all the measurements may be assumed to be uncorrelated with each other. In such examples, the cutoff value that gives the desired Type II error may be determined. Additionally, determinations may be made for what cutoff value can give us the desired balance between Type I errors and Type II errors.

FIG. 9 shows an example of measured data which may be stored in a database for searching. In the example, a control number 902 may be assigned to each sample gemstone. In FIG. 9, each of the data entries is of the same stone with control number “110107935652” 902 as merely an example. The next column is of a key 904 of an entry. A key may be a set of numbers corresponding to the feature measurements at issue. In the example of FIG. 9, a feature of a single edge with two corresponding facets is used. Therefore, the key shows two values because that is how many values that Feature 1 has, where the first value is the distance, and the second value is the angle, referenced in bin numbers, e.g., (0,375). As described, the rounded measurements of the actual measurements produce numbers that the system may expect to match exactly in the database. If the bin sizes are too small, then the measurement of a matching feature might go into a different bin, and it will not count as a match. If the bin size is too large, then it can increase the likelihood of counting a feature as a match that really should not be a match. Bin numbers do not have units, and bin sizes may relate to the overall performance of the system. The database of control numbers 902, keys 904 and feature measurement bin numbers may include a hash table, in one example. Below includes more examples and description of bins as used in the systems and methods here. FIG. 6 shows a similar example. In some examples, the angle and/or linear measurement may be rounded in order to standardize the data. In some examples, any kind of units may be used for measuring and storing data corresponding to the angles and/or linear measurements such as but not limited to angle degrees, angle radians, linear distance in nanometers, millimeters, centimeters, or any other measurement, alone or in combination.

The next column in the example of FIG. 9 shows repeat counts 906. In some examples, a single stone may include multiple features such as edges and facets with the same or substantially the same measurements. That is because some gemstones are cut such that facet patterns may be polished throughout the stone in a repeated fashion. In the example of FIG. 9, the repeat count 906 chronicles the number of repeated values found in a single stone. Using such a repeat count may save compute resources, instead of saving the same key values many multiple times. The last column in the example is the number of features 908 measured on the individual stone. The number of measured features 908 will depend on the type of feature that was selected for analysis (see FIGS. 6 and 7) as well as the particular gemstone under analysis. These values may be used as described herein to determine score and/or relative scores for a gemstone, in a matching exercise.

### Database Bin Examples

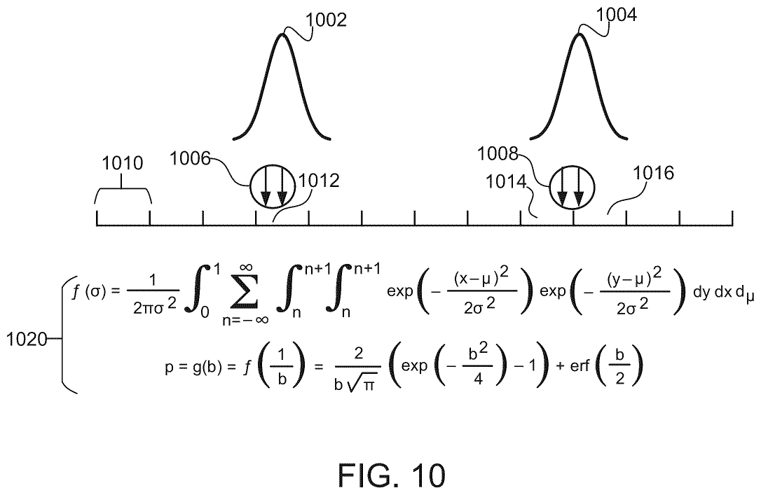

In examples where gemstone features are used for searching and matching, database management may depend on what features are analyzed and how many numbers or measurements are associated with each feature set under analysis. FIG. 10 shows two measurements stored in the database 1002, 1004.

In such examples, the systems and methods may include arranging the database using pre-determined bins 1010 or ranges of results to store the feature results in, to be accessed by the database. Using such bins appropriately sized, the ranges of the various feature measurements may be captured yet remain statistically accurate when used later for identifying matching feature measurements. Binning, however, may cause measurements of matching features to go into different bins due to measurement error or lack of precision, resulting in those matching features being counted as non-matches. In some examples, it may be possible to overcome or reduce the effect of matching features being counted as non-matches by including enough features in the sample gemstone that there a preponderance of matching features are counted as matches. This indicates the importance of setting good bin sizes. Without bins of results, the odds of matching measurements are very small (e.g., near zero), and rounding errors and measurement errors may not ever produce enough matches to be useful.

In FIG. 10, predetermined bins 1010 are shown in graphical form with the stored number representations as statistical curves 1002, 1004 and the actual measurements 1006, 1008 above the bins 1010. In the example, one set of two feature measurements 1006 both fall within the same bin 1012. There would be no problem with that situation, for storing and comparing this feature measurement for later samples. But in another analysis, the two measurements 1008 fall into different bins 1014, 1016. This situation might cause a problem for later comparison, if the one averaged number 1004 stored in the database for this feature were actually straddling two bins 1014, 1016. To combat this, choosing a bin 1010 with a statistically useful bin size may cut down the number of measurements sets that fall into multiple bins. The formula shown in FIG. 10 may be used for determining bin sizes for data storage.

In FIG. 10, equations 1020 are shown which may be used to predict the probability for a particular standard deviation of bell curve probability and standard deviation of bin sizes. That is, using bins, effort may be taken to minimize the probability of recording the same measured dimension or feature twice, in different bins, e.g., due to measurement imprecision. As part of this analysis, the formulas help determine, as a change in bin size b, what probability there might be two measurements of the identical dimension or feature falling into the same bin? Also, instead of changing the bin size, b, in units of standard deviation, what probability p, might there be of two different measurements of the same dimension or feature falling into the same bin?

By selecting an appropriate bin size for storing the data of the feature sets, they may be searched and matched using the database and corresponding computer assets. While binning may be one-dimensional for purposes of illustration, actual implementations can be two-dimensional or six-dimensional, for example, depending on the feature type and its complexity.

### Matching Examples

In some examples, it may be useful to utilize the measurements of a sample under analysis and compare those measurements to a database of previously measured samples, in order to attempt to determine a match. This may be useful in cases where a sample is sent into a lab for grading, graded, sent back to a customer, and then send back in for grading again. It may be useful to identify that such a stone was previously graded, even if the stone were slightly manipulated, polished, or shined. Scores and/or Relative Scores as described herein, may be used to compare a sample under analysis to a database of previously measured samples in order to determine a match.

Thus, once stored in the database, the system and methods may be able to lookup stored features for comparison and identification. Multiple features, such as six features, may become a single number index for lookup. In such examples, after the measurements are scaled an index may be created by rounding or truncating each number to the nearest integer. Continuing with the example, if there are six of these integers, and the bits from the binary representations of the integers are interleaved to create a single integer with six times as many bits. This becomes the database key to lookup the feature. Because of the interleaved bits, this key has the property that neighboring measurements that have been rounded to integers that differ by one tend to have keys that are near in value to this one.

In an example embodiment, a test wireframe can have a number of features, and a specific feature can be looked up in the database to find all features that match (i.e. are within a threshold similarity). In this example embodiment, there can be around 50,000 of such matches per feature in this implementation.

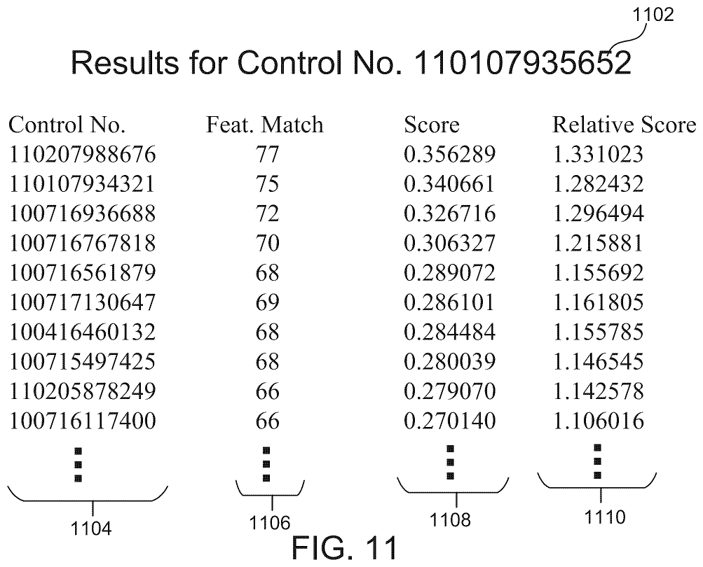

FIG. 11 shows an example data set for matching measured features. Similar to FIG. 9 where measurements for one stone are recorded, the data in FIG. 11 shows results of an attempt to match a measured stone with the data in the database.

In FIG. 11, the results for matches of a particular stone under analysis with control number 110107935652 are shown 1102. The first column 1104 shows different stone control numbers that have shown to be a potential match with the features saved for the stone under analysis 1102. In some examples, the database may contain many thousands of control numbers and corresponding underlying feature data for each. The example showing just a few is to highlight an example where the top data calculations are considered for a match as described herein, with the control numbers ranked in the list according to their score and relative score as described. The next column shows the number of matching features 1106 for each of the stones in the first column 1104 with the stone under analysis 1102. The next column shows the score calculated 1108 for each of these stones, as described herein. The last column 1110 shows relative scores for each of the stones 1104 as compared to the stone under analysis 1102 as described herein. A match of the stone under analysis 1102 may be made by selecting the match from the first column 1104 using the highest score 1108 and/or relative score 1110. Such matches may even be made if minor adjustments or polishing was done to a stone in between being measured. In such a way, the systems and methods here may be useful in determining if the stone under analysis 1102 was previously measured and now matched.

In the example of FIG. 11, only one direction of the matching is shown. And because sometimes, not all of a stone's features are measured, it may still be possible to match stones using what is measured. In such examples, if the first stone 110207988676 has 77 out of 150 features matching the stone under analysis 110107935652 but that stone may have fewer features measured. In that example, stone 11010793562 has 77 out of 129 features that match stone 110207988676. These stones may still be compared, even if different numbers of features are analyzed in each stone.

### Score Examples

In some examples, a Score 1108 for the match may be determined as a percentage of features matched out of both stones multiplied together. For example, if 77 out of 150 features match one and 77 out of 129 features match the other, then multiplied together would result in (77/150=0.5133333 and 77/129=0.59689922 so 0.513333×0.59689922=0.30640824 which is the score for that stone match pairing). A theoretical score of 1.0 would be a perfect match. The scores 1108 for each match pairings against the stone under analysis 1102 may be listed in rank order.

In some examples, additionally or alternatively, a Relative Score 1110 may be calculated as the score for that stone, and the score for another stone later down on a ranked list of gemstone scores, once the list of all comparisons is compiled and ranked from highest to lowest. This relative score 1110 can give a perspective as to how much better the match is for one score than others down the chart. For example, the number of scores could be two, five, six, eight, ten, twelve or fifteen scores. In some examples, then, the Relative Score 1110 could be the score of the first stone analyzed 1104 and the score of the eleventh stone analyzed, added together (ten down the list). The Relative Score 1110 of the second stone would be that second stone's score divided by the twelfth stone score. In some examples, a score of 1.5 may be a very high score. Once determined, 1110, the Relative Scores may help rank order the stones 1104 for a best match against the stone under analysis 1102.

In some instances, matching feature can be sorted by wireframe ID, so that all the matching features from a database wireframe are grouped together. Due to symmetries, it is possible for there to be more than one matching feature in the database wireframe for a given feature in the test wireframe, but it may only be counted as one match.

Similarly, multiple features in the test wireframe might match to a single feature in the database wireframe but can only count as 1 match. If multiple test wireframe features all match multiple database wireframe features, the set of matched features from the test wireframe can be assigned to the database wireframe, which maximizes the match count.

If a test wireframe has “nt” features, and a database wireframe has “nd” features, and there are a total of “m” matching features between the wireframes, then the raw score of the database wireframe can be represented as (m/nt)*(m/nd).

Additionally or alternatively, another way of scoring matches may include a validation step, where the entire wireframes of the top potential matches would be compared to see if the features are in the same relative orientations. If they are, this could provide a definitive match.

In some instances, the database wireframes can be sorted by score. In an example, a top 10 or 20 scoring wireframes can be provided in a table. Further, a rule can be used to assign labels to each wireframe, such as “MATCH,” “POSSIBLE MATCH,” or “NOT A MATCH” to each of the wireframes in the table. The rule can be based on the number of feature matches for the database wireframe, the raw score of the wireframe, and a comparison between that raw score and the raw scores of the database wireframes below it in the table.

In some instances, the system can calculate a relative score by dividing the raw score by the raw score of the wireframe that is 10 places lower in the table. If that value is at least 1.5, the wireframe can be a match. In particular, if the raw score is very low, then the wireframe is usually not a match even if the relative score is greater than 1.5.

### Example Analysis and Comparison Steps

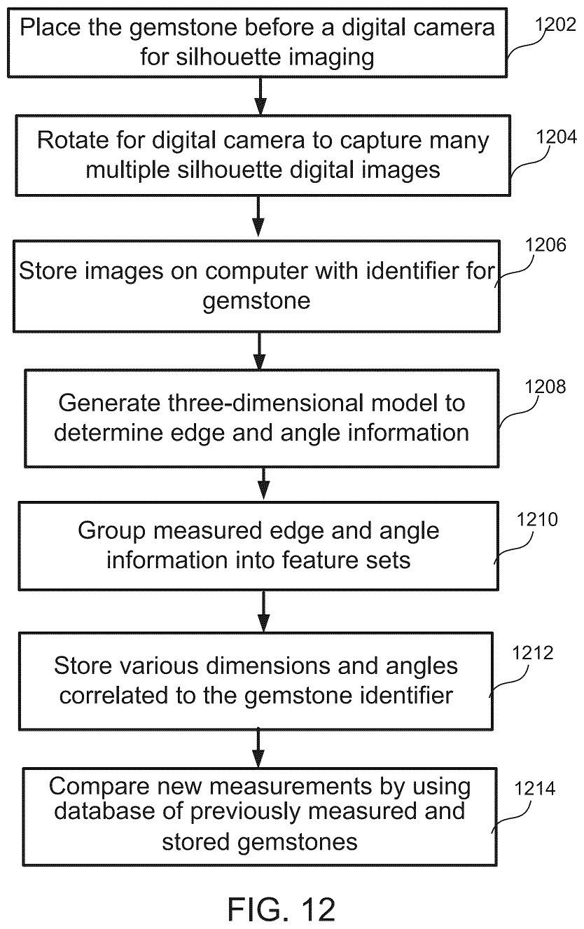

In accordance with the descriptions herein, FIG. 12 shows example method steps that may be conducted using the systems described herein. For example, FIG. 12 illustrates that the first step in analyzing, identifying and then matching a gemstone, may be to place the gemstone before a digital camera such that a silhouette of the gemstone may be captured in digital image 1202. Next, the gemstone may be rotated on a stage or table, allowing the digital camera to capture many multiple silhouette digital images of the gemstone, from many multiple angles 1204. These steps are detailed in FIG. 2 and accompanying description.

The images may be sent and/or stored at a computer with a processor and memory and identified with an identifying number, symbol, name, or other identifying and searchable mark 1206. The computer may then generate a three-dimensional model in order to calculate distance measurements for edge features and angle measurements for edge, vertex, and facet measurements 1208. The analysis of distance and angles may be determined by the computer analyzing the digitized images and determined coordinates for vertices and angles from the digital images made up of pixels. The computer may be programmed with a conversion distance criteria for what the camera arrangement captures a digital image and counts pixels to convert to a linear distance and/or angle or any other measurement programmed by the system. Once a certain number of measurements are taken for a gemstone, collections of edge and angle measurements may be grouped into feature sets assigned to the gemstone for storage 1210. These steps are detailed in FIGS. 4, 5, 6, 7 and accompanying description.

Once each of the combination of feature sets is determined, and each given its converted measured values, the various values and features may be stored and correlated to the gemstone identifier in a database 1212. These steps are detailed in FIG. 9 and accompanying description.

Once a database of gemstones and their measured criteria are saved, they may be used to compare to a newly measured gemstone for potential matching. In such cases, a stone may be sent to a lab many multiple times for analysis, and the matching described herein, may allow for correlation between earlier performed analysis and later performed analysis of the same gemstone.

In such examples, new feature measurements are taken of the gemstone as described above. Then, the system may utilize the measured features of the new stone to compare to a database of previously measured and stored gemstones 1214. In some embodiments, this may include calculating a Score and/or a Relative Score as described herein. These steps are detailed in FIG. 11 and accompanying description. In some example embodiments, various database structures such as those described in FIGS. 8 and 10 and accompanying description may be used to search as described herein.

### Example Computer Devices

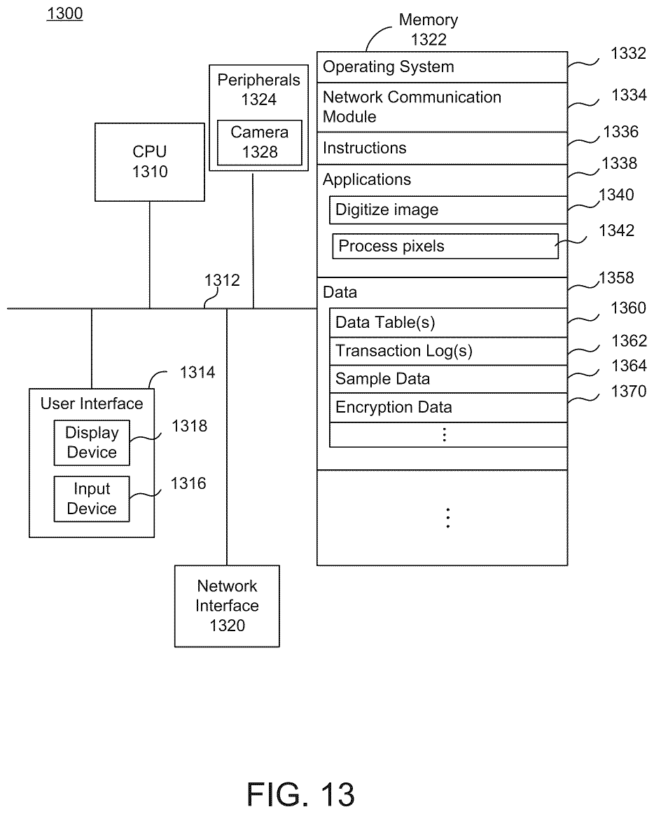

FIG. 13 shows an example computing device 1300 which may be used in the systems and methods described herein. In the example computer 1300 a CPU or processor 1310 is in communication by a bus or other communication 1312 with a user interface 1314. The user interface includes an example input device such as a keyboard, mouse, touchscreen, button, joystick, or other user input device(s). The user interface 1314 also includes a display device 1318 such as a screen. The computing device 1300 shown in FIG. 13 also includes a network interface 1320 which is in communication with the CPU 1320 and other components. The network interface 1320 may allow the computing device 1300 to communicate with other computers, databases, networks, user devices, or any other computing capable devices. In some examples, the method of communication may be through Wi-Fi, cellular, Bluetooth Low Energy, wired communication, or any other kind of communication. In some examples, the example computing device 1300 includes peripherals 1324 also in communication with the processor 1310. In some examples, peripherals include antennae 1326 used for communication. In some examples peripherals 1324 may include camera equipment 1328. In some examples, computing device 1300 a memory 1322 is in communication with the processor 1310. In some examples, this memory 1322 may include instructions to execute software such as an operating system 1332, network communications module 1334, other instructions 1336, applications 1338, applications to digitize images 1340, applications to process image pixels 1342, data storage 1358, data such as data tables 1360, transaction logs 1362, sample data 1364, encryption data 1370 or any other kind of data.

### CONCLUSION

As disclosed herein, features consistent with the present embodiments may be implemented via computer-hardware, software and/or firmware. For example, the systems and methods disclosed herein may be embodied in various forms including, for example, a data processor, such as a computer that also includes a database, digital electronic circuitry, firmware, software, computer networks, servers, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the embodiments or they may include a computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various machines may be used with programs written in accordance with teachings of the embodiments, or it may be more convenient to construct a specialized apparatus or system to perform the required methods and techniques.

Aspects of the method and system described herein, such as the logic, may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as 5PROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the descriptions have been specifically described herein, it will be apparent to those skilled in the art to which the descriptions pertain that variations and modifications of the various implementations shown and described herein may be made without departing from the spirit and scope of the embodiments. Accordingly, it is intended that the embodiments be limited only to the extent required by the applicable rules of law.

The present embodiments can be embodied in the form of methods and apparatus for practicing those methods. The present embodiments can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the embodiments. The present embodiments can also be in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the embodiments. When implemented on a processor, the program code segments combine with the processor to provide a unique device that operates analogously to specific logic circuits.

The software is stored in a machine readable medium that may take many forms, including but not limited to, a tangible storage medium, a carrier wave medium or physical transmission medium. Non-volatile storage media include, for example, optical or magnetic disks, such as any of the storage devices in any computer(s) or the like. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: disks (e.g., hard, floppy, flexible) or any other magnetic medium, a CD-ROM, DVD or DVD-ROM, any other optical medium, any other physical storage medium, a RAM, a PROM and EPROM, a FLASH-EPROM, any other memory chip, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles of the embodiments and its practical applications, to thereby enable others skilled in the art to best utilize the various embodiments with various modifications as are suited to the particular use contemplated. The scope of the invention should, therefore, be determined only by the following claims.

What is claimed is:

1. A method of identifying gemstones, the method comprising:
obtaining a set of measurements of a gemstone including measurements regarding vertices, edges, and/or facets of the gemstone;
grouping subsets of the measurements into multiple feature sets, each of the feature sets defining a feature of the gemstone; and
identifying one or more matching gemstone records in a database by comparing the features of the gemstone to one or more gemstone records stored in the database, each of the gemstone records including multiple recorded features representing record feature sets consisting of one or more measurements, and wherein comparing the features of the gemstone to the one or more gemstone records includes comparing each the features of the gemstone to at least one of the recorded features in the database to identify multiple matching features.

2. The method of claim 1, wherein:
each of the recorded features in the database includes a recorded feature set stored in the database, each of the recorded feature sets is associated with at least one of the gemstone records, and each of at least some of the recorded feature sets is associated with multiple gemstone records in the database; and
each gemstone record in the database has a corresponding control number stored in the database; and further comprising:
scoring at least some of the matching gemstone records based on their similarity to the gemstone to generate similarity scores; and
populating a list with the control numbers of at least some of the plurality of gemstone records based on the similarity scores.

3. The method of claim 1, wherein the step of obtaining measurements of the gemstone includes:
for each of multiple pairs of adjacent facets of the gemstone, obtaining an angle between the adjacent facets; and
for each of multiple pairs of adjacent vertices of the gemstone, obtaining a distance between the adjacent vertices.

4. The method of claim 1, wherein the step of obtaining measurements of the gemstone includes obtaining measurements of relative or absolute positional or angular relationships between vertices, edges, and/or facets of the gemstone.

5. The method of claim 1, wherein the features of the gemstone exclude feature sets having edge length measurements below a predetermined minimum length threshold or angular measurements within a predetermined coplanar threshold.

6. The method of claim 1, wherein none of the features includes a distance measurement or an angular measurement of any portion of a girdle of the gemstone.

7. The method of claim 1, wherein each of at least some of the feature sets includes the length of a first one of the edges and an angle between adjacent facets that meet along the first one of the edges.

8. The method of claim 7, wherein the subset of measurements comprising each of the feature sets is devoid of measurements of edges or facets of the gemstone that are not adjacent to at least one other edge or facet for which at least one measurement thereof is included in the subset.

9. The method of claim 1, wherein none of the recorded feature sets in the database includes more than six measurements.

10. The method of claim 1, wherein each of the recorded feature sets includes a predetermined number of measurements, and wherein the step of grouping subsets of the measurements of the gemstone into feature sets includes grouping a number of such measurements corresponding to the predetermined number of measurements of at least one of the recorded feature sets.

11. The method of claim 10, wherein the predetermined number of measurements of each one of the recorded feature sets does not exceed six measurements.

12. The method of claim 1, wherein each feature comprises one or more values specifying measurements of the feature set corresponding to the feature.

13. The method of claim 1, wherein each of the features is part of a taxonomy of features classifying each feature by feature type.

14. The method of claim 1, wherein identifying the one or more matching gemstone records further includes defining a metric used to determine which of the recorded features in the database are within a threshold similarity to each of the features of the gemstone.

15. The method of claim 14, wherein the metric comprises any of a Manhattan metric and a Euclidian metric that is pre-scaled such that a distance, in a coordinate space, between one of the feature sets and a corresponding recorded feature set is below a threshold value.

16. The method of claim 2, further comprising:
for each control number populated in the list, assigning a label specifying whether the corresponding gemstone record is predicted to be among the matching gemstone records based on the similarity scores computed; and
causing display of the list with the labels.

17. The method of claim 2, wherein the similarity score is based on the quantity of matching features relative to a total quantity of recorded features of the corresponding gemstone record.

18. The method of claim 2, further comprising:
generating, for each gemstone record, a relative score based on the similarity scores for multiple gemstone records in the database.

19. The method of claim 1, wherein the set of measurements of the gemstone are obtained from one or more images of the gemstone, wherein the one or more images are captured by: causing rotation of the gemstone on a stage and capturing, by a digital camera, the one or more images of the gemstone as the gemstone rotates on the stage, relative to the digital camera.

20. The method of claim 1, wherein the set of measurements is derived from one or more pixelated images of the gemstone including the steps of:
detecting multiple edges and/or vertices in the pixelated images of the gemstone;
generating a three-dimensional model of the gemstone using the detected edges and/or vertices; and
from the generated three-dimensional model, deriving distances between vertices, and angles between facets.

21. A non-transitory computer readable media with computer-executable instructions thereon configured to instruct a processor to perform a series of steps comprising:
obtaining a set of measurements of a gemstone including measurements regarding vertices, edges, and/or facets of the gemstone;
grouping subsets of the measurements into multiple feature sets, each of the feature sets defining a feature of the gemstone; and
identifying one or more matching gemstone records in a database by comparing the features of the gemstone to one or more gemstone records stored in the database, each of the gemstone records including multiple recorded features representing record feature sets consisting of one or more measurements, and wherein comparing the features of the gemstone to the one or more gemstone records includes comparing each the features of the gemstone to at least one of the recorded features in the database to identify multiple matching features.

22. The non-transitory computer readable media of claim 21, wherein
each of the recorded features in the database includes a recorded feature set stored in the database, each of the recorded feature sets is associated with at least one of the gemstone records, and each of at least some of the recorded feature sets is associated with multiple gemstone records in the database; and
each gemstone record in the database has a corresponding control number stored in the database; and
the step of identifying a matching gemstone record includes:
identifying, for each of the features of the gemstone, all recorded feature sets in the database that match the feature set of the feature within a threshold similarity, and
computing a similarity score for each of a plurality of the gemstone records based on a quantity of the features of the gemstone that match recorded features of said gemstone records; and
the instructions further instruct the processor to populate a list with the control numbers of at least some of the plurality of gemstone records, based on the similarity scores.

23. A system for analyzing gemstones, the system comprising:
a computer with a processor and memory configured to:
obtain multiple images of a gemstone;
derive a set of measurements from the images of the gemstone including measurements regarding vertices, edges, and/or facets of the gemstone;
group subsets of the measurements into multiple feature sets, each of the feature sets defining a feature of the gemstone; and
identify one or more matching gemstone records in a database by comparing the features of the gemstone to one or more gemstone records stored in the database, each of the gemstone records including multiple recorded features representing record feature sets consisting of one or more measurements, and wherein comparing the features of the gemstone to the one or more gemstone records includes comparing each the features of the gemstone to at least one of the recorded features in the database to identify multiple matching features.

24. The system of claim 23, further comprising:
a digital camera configured to capture the images of the gemstone.

25. The system of claim 23, wherein:
each of the recorded features in the database includes a recorded feature set stored in the database, each of the recorded feature sets is associated with at least one of the gemstone records, and each of at least some of the recorded feature sets is associated with multiple gemstone records in the database;
each gemstone record in the database has a corresponding control number stored in the database; and
the computer is further configured to populate a list with the control numbers of at least some of the plurality of gemstone records, based on the similarity scores.
